(19) United States
(12) Patent Application Publication
(10) Pub. No.: US 2026/0156626 A1
(43) Pub. Date: Jun. 4, 2026

(54) REDUNDANT TRANSMISSION IN A DISTRIBUTED MANUFACTURING AUTOMATION SYSTEM

(71) Applicant: BASF SE, Ludwigshafen am Rhein (DE)

(72) Inventors: Jan AUGUSTIN, Schwarzheide (DE); Ole GUETSCHOW, Schwarzheide (DE); Andreas SEIDE, Schwarzheide (DE); Harro BONNOWITZ

(21) Appl. No.: 19/123,991

(22) PCT Filed: Oct. 26, 2023
(86) PCT No.: PCT/EP2023/079987

§ 371 Date: Apr. 24, 2025

(30) Foreign Application Priority Data
Oct. 26, 2022 (EP) 22203898.6

(51) Int. Cl. H04W 72/0453

(52) U.S. Cl. CPC H04W 72/0453

(57) ABSTRACT

Disclosed herein is a method for redundant transmission in a distributed manufacturing automation system. The method includes: sending by an automation apparatus of the system a data item to a receiver through a first cellular network using a first sub-band of an industry frequency band, the first cellular network including a first base station and a first core network device; and sending by the automation apparatus the data item to the receiver through a second cellular network using a second sub-band of the industry frequency band, the second cellular network including a second base station and a second core network device.

### TECHNICAL FIELD

Various example embodiments relate to automation systems, and more particularly to an apparatus and method for redundant transmission in a distributed manufacturing automation system.

### BACKGROUND

New generations of radio systems and network architectures are expected to provide higher bitrates and coverage than existing systems. They are also expected to increase network expandability up to hundreds of thousands of connections. However, there is a need to further improve access to such systems in the field of manufacturing automation systems.

### SUMMARY

Example embodiments provide a method for redundant transmission in a distributed manufacturing automation system. The method comprises: sending by an automation apparatus of the system a data item to a receiver through a first cellular network using a first sub-band of a predefined frequency band, e.g. an industry frequency band, the first cellular network comprising a first base station and a first core network device, and sending by the automation apparatus the data item to the receiver through a second cellular network using a second sub-band of the predefined frequency band, the second cellular network comprising a second base station and a second core network device. The predefined frequency band in an example may be a licensed frequency band, licensed by a regulatory authority. The frequency band may cover a range of 3700-3800 MHz. In another example the predefined frequency band may be an unlicensed frequency band.

For example, the first sub-band and the second sub-band are different sub-bands or substantially may only do partially overlap. In this way interference of one-sub-band may do not affect or impact the other sub-band.

According to further example embodiments, a computer program product is provided. The computer program product comprises a computer-readable storage medium having computer-readable program code embodied therewith. The computer-readable program code is configured to implement the method of any of the preceding embodiments. According to further example embodiments, a system is provided. The system comprises a first cellular network and a second cellular network. The first cellular network comprises a first base station and a first core network device. The second cellular network comprises a second base station and a second core network device. The system further comprises an automation apparatus. The automation apparatus is configured for: sending a data item to a receiver through the first cellular network using a first sub-band of an industry frequency band and sending the data item to the receiver through the second cellular network using a second sub-band of the industry frequency band.

According to further example embodiments an automation apparatus is provided for a distributed manufacturing automation system. The automation apparatus comprises a dual band air interface and a processor being configured for: sending using the interface a data item to a receiver through a first cellular network using a first sub-band of an industry frequency band, the first cellular network comprising a first base station and a first core network device, and sending using the interface the data item to the receiver through a second cellular network using a second sub-band of the industry frequency band, the second cellular network comprising a second base station and a second core network device.

### BRIEF DESCRIPTION OF THE DRAWINGS

The accompanying figures are included to provide a further understanding of examples and are incorporated in and constitute part of this specification. In the figures:

FIG. 1 depicts a distributed manufacturing automation system in accordance with an example of the present subject matter,

FIG. 2 depicts a distributed manufacturing automation system in accordance with an example of the present subject matter;

FIG. 3 depicts a distributed manufacturing automation system in accordance with an example of the present subject matter;

FIG. 4 depicts a wireless communication system in accordance with an example of the present subject matter;

FIG. 5 is a flowchart of a method for redundant transmission in a distributed manufacturing automation system according to an example of the present subject matter;

FIG. 6 is a flowchart of a method for redundant transmission in a distributed manufacturing automation system according to an example of the present subject matter;

FIG. 7A is a flowchart of a method for providing frequency resources according to an example of the present subject matter;

FIG. 7B is a diagram illustrating an industrial frequency band according to an example of the present subject matter;

FIG. 7C is a diagram illustrating an industrial frequency band according to an example of the present subject matter;

FIG. 8 depicts an automation apparatus in accordance with an example of the present subject matter;

FIG. 9 depicts a wireless communication system in accordance with an example of the present subject matter.

FIG. 10 depicts a distributed manufacturing automation system distributed over different locations linked by a wireless communication system in accordance with an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

Automation, in the context of manufacturing, may refer to the use of devices such as sensors, actuators, robots and computers to automate manufacturing processes. The manufacturing process may, for example, refer to the steps of a method used to prepare a composition. The manufacturing process may involve the use of manufacturing facilities such as equipments, raw materials, machinery, tools, plant etc. The manufacturing process may have one or more properties (herein referred to as manufacturing properties). Examples of manufacturing properties may comprise the temperature, the pressure, the process time, the melting point of a substance, the flexural strength of a steel, the resistance of an electrical conductor etc. The manufacturing process may have one or more parameters (herein referred to as manufacturing parameters) that enable control of the manufacturing process. Examples of manufacturing parameters may comprise mixing rate, temperature etc.

Automation, and thus control, of the manufacturing process may be performed by acquiring process data, analysing the process data and automatically adjusting a manufacturing parameter based on the analysis. The process data may comprise values of one or more manufacturing properties of the manufacturing process. Different types of control may be provided depending on the acquired process data and/or type of the analysis and/or type of controlled manufacturing parameters. For example, one type of control may check property values against thresholds and adapt one or more manufacturing parameters accordingly. Another type of control may perform a more sophisticated (time consuming) analysis of the manufacturing property in order to adjust one or more manufacturing parameters. The different types of control may have different time frames of the control e.g., the control may be real-time or non-real time control.

The control of the manufacturing process may advantageously be performed by a distributed manufacturing automation system. The distributed manufacturing automation system may comprise dispersed manufacturing facilities and various devices which may be spread across multiple systems located in different locations. The distributed manufacturing automation system may be implemented in accordance with a functional model in order to enable the different types of control of the manufacturing process. The functional model may define a function of individual devices, how data is exchanged and formatted within the distributed manufacturing automation system, and how the devices are interconnected within the distributed manufacturing automation system. In one example, the functional model may be the ISA-95 functional model. The ISA-95 functional model may, for example, be a hierarchical pyramidal model or a network-based architecture model.

A communication network, e.g. a data communication network, a wide area network and/or a wireless communication network, may be used in order to link the different parts of the distributed manufacturing automation system over long distance. The communication network may be adapted to maintain and ensure the different requirements of the functional model of the manufacturing automation system over the long range of data communication.

An automation apparatus may be the linking component and/or the interface between the automation and manufacturing domain of an industrial campus over the wide distance of data communication provided by a communication network. The automation apparatus therefore may be adapted to map the requirements of a functional model of the manufacturing automation system to the communication network linking different locations of an industrial production network. In this way supply chains may be linked and the digitalisation of production, e.g. in the chemical industry, may be supported. For example, the functional model may describe a hierarchical arrangement of devices of the distributed manufacturing automation system according to a field level, control level, supervision level and information level.

In one example, the lower the level in the hierarchical pyramid model the closer the level to raw data. Raw data may be provided as substantially analogue data and/or bus data. Raw data may also be provided as digital data in a bus protocol format after processing the analogue data. In an example, the higher the level of the hierarchy the more packaging data may be included in the exchanged data. For example, each hierarchical layer adds a header for the specific layer to the data. In case that the hierarchy is arranged according to the OSI network model, each layer adds its own PDU (Protocol data unit). The one and/or plurality of interface(s) of the automation apparatus may be adapted to unpack and/or pack data according to the connected network hierarchy. The PDU may embed the payload data which substantially are the data of the lowest hierarchical level, e.g. the field device data.

In another example the level of the hierarchical pyramid model may be indicated by a level indicator, level identifier and/or level ID. The level indicator may be added to a data package distributed in a network in order to show the association with a predefined level. Devices belonging to a specific level may be grouped together by using the same level indicator. The differentiation between participants of a functional level may be realised by employing sub-network masks used for filtering predefined functional groups of devices and their members. A sub-network mask may be a bit pattern that allow for filtering data packets and/or data streams by XOR operations. The level identifier may be a bit pattern where the set bit represents the level in the pyramid. For example, in a 5 bit header the bit pattern 00001 represents level 1, 00010 represents level 2 etc. In other words, the length of the level identifier corresponds to the number of available levels and the position where a bit is set in the header corresponds to the level to which a data packet is associated with.

The automation apparatus may have a level identifier allocation device which receives input from a specific network of a level and adds the respective bit pattern to traffic from that respective network. The bit pattern may be used for an internal routing process inside the automation apparatus. In an example the automation apparatus may have different ports for connecting the different networks corresponding to a specific level. E.g.

Port 1 is allocated to field device network, level 1, port 2 is allocated to automation device network, level 2 etc.

In another example, each level may form a separate network, e.g. a VLAN (virtual local area network). In such an example, devices belonging to the same level may be indicated as belonging to the same network. In an example the differentiation between different devices may be made by registering an address, e.g. IP address, MAC address in a network dedicated to a specific level.

A combination of the different level indicators and level allocations may be possible.

The level of a functional model may be mapped to a quality parameter for a network and to specific network parameter of the backbone network. One quality parameter may be latency, another parameter may be reliability.

In an example a manufacturing device, e.g. a sensor, may request a predefined reliability for data transmission. Such a request may be made by the sending of a request package from the manufacturing device to the automation apparatus. The automation apparatus may be adapted to verify whether the requested predefined quality may be met by the backbone network in order to guarantee the same high reliability that is required for a certain level of devices of a functional level of the functional model.

The field level may be the lowest level which may include field devices such as sensors and actuators. The field devices may be configured to transfer the process data of the manufacturing process to the next higher level for monitoring and analysis. For example, sensors may convert real time manufacturing properties such as temperature and pressure into sensor data. The sensor data may be analogue data. After preprocessing, e.g. by A/D converters the sensors may also provide digital data. The automation apparatus may comprise such an A/D converter for a direct sensor connection. The sensor data may further be transferred to a controller so as to analyze the real time properties. Actuators may convert electrical signals from controllers into mechanical means to control the manufacturing process.

The control level and/or automation level may consist of various controllers such as Programmable Logic Controllers (PLCs) which may acquire the manufacturing properties from various sensors. The controllers may drive actuators based on the processed sensor data and control technique.

The supervision level may consist of monitoring devices that enable intervening functions, supervising various manufacturing properties, setting production targets, historical archiving, setting machine start and shutdown, etc. The information level may manage the whole distributed manufacturing automation system. The tasks of this level may include production planning, customer and market analysis, orders and sales etc.

Communication of data between the devices of the distributed manufacturing automation system may be performed over one or more communication networks. The communication network(s) may be present in all the levels to provide continuous flow of data. The present subject matter may further improve the communication of data in the distributed manufacturing automation system by using wireless connectivity. This may provide flexible and efficient implementation of the distributed manufacturing automation system. The wireless connectivity may enable communication of data between devices of the distributed manufacturing automation system. In case of a hierarchical functional model, the wireless connectivity may enable communication of data between the hierarchical levels. Additionally, or alternatively, the wireless connectivity may enable communication of data between the distributed manufacturing automation system and other external systems.

However, the communication through the wireless connectivity may need to fulfill reliability and latency requirements such as the ultra-reliable low-latency communication (URLLC) requirements. For that, the present subject matter may use a dedicated deployment of cellular networks and dedicated frequency assignments.

For example, a first cellular network and second cellular network may be provided. The first cellular network may comprise a first base station (herein named BS1) and a first core network device (herein named CN1). The second cellular network may comprise a second base station (herein named BS2) and a second core network device (herein named CN2). The two cellular networks may, for example, be owned by the same or different communication operators. The first and second cellular networks may enable high-speed wireless connectivity, wherein the speed of wireless connectivity is higher than a minimum speed that fulfills the URLLC requirements. The minimum speed may, for example, be 10 GB per second. The first and second cellular networks may operate according to the same or different wireless communication technologies. For example, the first cellular network may be a fifth-generation (5G) cellular network and/or the second cellular network may be a 5G cellular network. Each of the base stations BS1 and BS2 may include a wireless communication station. The base station may, for example, be a gNodeB (gNB). The base station may be installed at a fixed terrestrial location and used to facilitate communication in the respective cellular network. The base station may serve devices of the distributed manufacturing automation system in a given geographical area. Each of the core network devices CN1 and CN2 may implement one or more functionalities of a data plane and control plane. The functionalities may, for example, include at least one of: a user plane function (UPF), Network Exposure Function (NEF), Core Access and Mobility Management Function (AMF), Session Management Function (SMF), Policy Control Function (PCF) and Unified Data Management (UDM).

An automation apparatus with redundant transmission capabilities is provided. The automation apparatus may transmit the same data item (herein named d_item) to a receiver through the first cellular network and the second cellular network. This redundant transmission of the data item d_item may, for example, be triggered by the detection of a trigger event by the automation apparatus. The trigger event may, for example, be a failure, a given status of a timer etc. In a further example, the trigger event is one of the group of events consisting of receiving data, receiving a predefined data type, elapsing of a timer, a signal indicating the presence of data, overflow of a buffer e.g. a queue, and detecting a failure. The receiver of the data item d_item may be part of the distributed manufacturing automation system or of another external system. The data item d_item may, for example, comprise one or more data packets. The one or more data packets may be assembled and/or dissembled according to the levels of the hierarchical pyramid model, e.g. by adding and/or removing PDUs. In another example the headers may have a predefined bit pattern. The content of the data item d_item may, for example, represent collected process data of the manufacturing process. The base station BS1 and BS2 and the automation apparatus may be configured to use a time division duplex (TDD) technique for data transmission.

The automation apparatus may be any device of the distributed manufacturing automation system that contributes to the control of the manufacturing process. The automation apparatus may, for example, be a sensor, actuator, PLC, computer etc. The automation apparatus may include two or more separate sets of circuitries for exchanging signals with the first cellular network and the second cellular network and/or with the one or more cellular networks. The separate sets of circuitries may provide a dual or more frequency band air interface. In particular, the separate sets of circuitries provide two separate receive chains. With the separate receive chains, the automation apparatus may connect simultaneously to the first and second cellular networks. The automation apparatus may comprise first identification data that enables the automation apparatus to authenticate with the first cellular network and thus communicate through the first cellular network. The automation apparatus may comprise second identification data to authenticate with the second cellular network and thus communicate through the second cellular network. For example, the automation apparatus may comprise a first Subscriber Identity Module (SIM) card, which uniquely identifies the automation apparatus and establishes the radio parameters (e.g., the first frequency sub-band) needed to communicate with the first base station. The automation apparatus may further comprise a second SIM card, which uniquely identifies the automation apparatus and establishes the radio parameters (e.g., the second frequency sub-band) needed to communicate with the second base station.

The automation apparatus may be adapted for scheduling data according to predefined criteria. E.g. it may be possible that different grades of reliability exist for different levels. However, it may happen that a bulk of data arrive having low reliability requirements. However, the quantity of arriving data is such high that they may not be handled from the connection with the appropriate reliability level. Then a connection may be used of a higher reliability level, if such connection may at the moment of data arriving is available. For example, field device data may be allocated to a high reliability requirement. Planning data may be allocated to a low reliability requirement. However, e.g. a backup is made and high data traffic suddenly appears. If at the same time the activity of the high reliability level, e.g. field devices, is low, this free capacity may be used for the traffic with the lower priority. In this case the automation apparatus may have a scheduling device for distributing the traffic, e.g. a data item, to the different channels, in particular to the relevant cellular networks. The scheduling may allow for an effective use of the available frequency bands. An operator in the industrial field may do not have to pay extra fees for additional bandwidth within the predefined frequency band. Thus, an optimum use of the leased frequency bands may be made.

The present subject matter may provide an isolated deployment in which each cellular network has the necessary components for transmitting data independently of the other cellular network. With this isolated deployment, the transmitted data item d_item may experience different transmission conditions. This may increase the probability of a successful transmission of the data item d_item because the probability of a simultaneous loss of communication in two independent transmission paths may be low.

The transmission of the data item d_item may, for example, be performed using the industry frequency band which is a predefined frequency band allocated to one operator. The industry frequency band may be a frequency band. The industry frequency band may be a contiguous section of radio spectrum frequencies. The industry frequency band may be allocated for data communication in manufacturing automation systems in a specified region. The industry frequency band may be a licensed spectrum. The industry frequency band may be assigned by a third-party service such as the German Bundesnetagentur service. The industry frequency band may, for example, be a 3700-3800 MHz band, but it is not limited to. The industry frequency band may be allocated or assigned in multiples of a frequency block. The width W_{block} of the frequency block may, for example, be 10 MHz (W_{block}=10 MHz), 5 MHz (W_{block}=5 MHz) or other width values.

The data item d_item may be sent through the first cellular network using a first subband (herein named sBand1) of the industry frequency band. The data item d_item may be transmitted through the second cellular network using a second sub-band (herein named sBand2) of the industry frequency band.

The first sub-band sBand1 may not be overlapping with the second sub-band sBand2. This may further improve the isolation between the two setups used for the transmission of the data item d_item through the first cellular network and the second cellular network. Consequently, the reliability of the transmission of the data item may further be improved as it is performed using two well separated setups.

According to one embodiment, the industry frequency band is divided into two sets of sub-bands. A first set of n1 sub-bands (referred to as sBand1₁, sBand1₂ . . . sBand1ₙ₁, where n1 is an integer higher than one) is allocated for transmission through the first cellular network. A second set of n2 sub-bands (referred to as sBand2₁, sBand2₂ . . . sBand2ₙ₂, where n2 is an integer higher than one) is allocated for transmission through the second cellular network.

The number of sub-bands in the first set of sub-bands is the first number n1. The number of sub-bands in the second set of sub-bands is the second number n2.

By splitting the industry frequency band, the channels used in the sub-bands may be used concurrently at maximum power without leaking signals to each other, so as to avoid interference between different channels. The combination of a plurality of channels may form a combined channel with a predefined reliability. The reliability may be measures as MTBF (Mean Time Between Failure). The separation of the sets of sub-bands for the usages between the first cellular network and the second cellular network may thus minimize the interferences between the first setup and the second setup.

In one example, the first sub-band sBand1 used for the transmission of the data item d_item may be any one of the first set of sub-bands e.g., sBand1=SBand1ₙ₁. The second sub-band sBand2 used for the transmission of the data item d_item may be any one of the second set of sub-bands e.g., sBand2=sBand2₁. Alternatively, the first and second sub-bands sBand1 and sBand2 may be selected from the first and second sets of sub-bands respectively such that the distance or gap between the first sub-band sBand1 and the second sub-band sBand2 is maximized. This alternative may further improve the transmission reliability of the data item d_item by further reducing the interference issues.

The first set of sub-bands sBand1₁, sBand1₂ . . . sBand1ₙ₁, may or may not have the same frequency range. The second set of sub-bands sBand2₁, sBand2₂ . . . sBand2ₙ₂ may or may not have the same frequency range. The number of sub-bands n1 in the first set may or may not be equal to the number of sub-bands n2 in the second set. This controlled division of the industry frequency band may enable a flexible scheduling of data transmissions in the distributed manufacturing automation system. For example, different sub-bands may be used to carry data with different desired rates.

In one example, the number n1 sub-bands sBand1₁, sBand1₂ . . . sBand1ₙ₁ is equal to two, n1=2. And the first set of sub-bands comprises the first sub-band sBand1 and another sub-band, named first broad sub-band hBand1 for transmission of high bandwidth data. Similarly, n2=2 and the second set of sub-bands comprises the second sub-band sBand2 and another sub-band, named second broad sub-band hBand2 for transmission of high bandwidth data. The sub-bands sBand1, hBand1, sBand2 and hBand2 occupy the frequency ranges W_{sBand1}, W_{hBand1}, W_{sBand2} and W_{hBand2} respectively. The present subject matter may enable different configurations of the frequency ranges. In one example, W_{sBand1}<W_{hBand1} and W_{sBand2}<W_{hBand2}. In one example,

$${W}_{sBand 1} = \frac{2}{\text{?}} \times {W}_{hBand 1} and {W}_{sBand 2} = \frac{2}{\text{?}} \times {W}_{hBand 2} .$$

$$\text{?} \text{indicates text missing or illegible when filed}$$

Alternatively, or additionally, W_{sBand1}=W_{sBand1} and W_{hBand1}=W_{hBand2}.

According to one embodiment, the data item is a first type of data. The method further comprises: sending by the automation apparatus to the receiver a second type of data through the first cellular network using the first broad sub-band hBand1 or through the second cellular network using the second broad sub-band hBand2. In an example the different types of data may be copies of data. The different types of data may have different reliability requirements.

According to one embodiment, the sending of the data item d_item through the first cellular network comprises: selecting a first user plane path between the automation apparatus and a data network comprising the receiver. The first user plane path comprises a first user plane function network element, UPF1, of the first core network device. The data item d_item may be sent along the first user plane path.

The sending of the data item d_item through the second cellular network comprises: selecting a second user plane path between the automation apparatus and the data network. The second user plane path comprises a second user plane function network element, UPF2, of the second core network device. The data item d-_item may be sent along the second user plane path. The data network may, for example, be a network of devices of the distributed manufacturing automation system or an external network such as Internet. The network of devices may, for example, belong to one level of the levels of the hierarchical model.

For example, once the automation apparatus is activated, the first core network device may initialize the first user plane by, for example, assigning a first IP address to the automation apparatus and the second core network device may initialize the second user plane by, for example, assigning a second IP address to the automation apparatus. The automation apparatus can thus use the first user plane path through the first user plane function network element and the second user plane path through the second user plane function network element.

In order to further reduce interference issues, each of the first and second user plane paths may be isolated using a resource isolation which provides exclusive access to resources. The resource isolation may, for example, be implemented using network slicing techniques. Network slicing may ensure that the user plane path is provided with exclusive network resources.

According to one embodiment, the sending of the data item d-_item through the first cellular network comprises: sending the data item d_item to a sensor gateway, forwarding the data item d_item by the sensor gateway through a physical connection to a router, and forwarding over the air by the router the data item d_item to the first cellular network. The sending of the data item d_item through the second cellular network comprises: sending the data item d_item to the sensor gateway, forwarding the data item d_item by the sensor gateway through the physical connection to the router; and forwarding over the air by the router the data item d_item to the second cellular network.

The automation apparatus may comprise a transceiving device, i.e. a device for transmitting and/or receiving data, for receiving input data, e.g. process data, raw process data or already the data item d_item. A connection between the transceiving device of the automation apparatus and the sensor gateway may be a wireless connection or wired connection. The transceiving device may be used as allocation device.

In other words, the method further comprises: sending the data item d_item to a sensor gateway, forwarding the data item d_item by the sensor gateway through a physical connection to a router, and forwarding over the air by the router the data item d_item to the first cellular network. The sending of the data item d_item through the first cellular network comprises: forwarding over the air by the router the data item d_item to the second cellular network. The sending of the data item d_item through the second cellular network comprises: forwarding over the air by the router the data item d_item to the second cellular network.

In an example the transceiving device makes a copy of the data item d_item. In another example the router makes a copy of the data item d_item. In a further example the transceiving device makes a copy of a part of the data item d_item and the router makes a copy of the other part of the data item d_item. The number of copies may correspond to the number of available networks.

The automation apparatus, the router, the gateway and/or the transceiving device may decide how many data paths are used for a specific data item d_item and/or how many copies are therefore generated from the d_item. Different types of data may be treated differently even if they are comping from the same device. In an example an end device may generate raw data and/or processed data. In an example the raw data may be transmitted by the automation apparatus via a single connection and the process data may be transmitted via the two and/or more data items. In an example a camera may generates video signals and processed alarm notification. The alarm notification may be generated on the camera, for example by detecting a movement in the stream of video data in the video signal. The processed data may have a higher priority than the raw video stream data. Therefore, the processed data are sent by using the at least two cellular networks, whereas the raw data may be only sent via a single cellular network with no preparation of duplication. Thus, data coming from one data source may be separated in different types of data having different reliability requirements.

According to one embodiment, the method further comprising placing the first cellular network in a first demilitarized zone, DMZ, and placing the second cellular network in a second demilitarized zone. For example, placing the first cellular network in a first DMZ may comprise providing the first cellular network with a first DMZ network. Placing the second cellular network in a second DMZ may comprise providing the second cellular network with a second DMZ network. Each of the first and second DMZ networks may comprise systems enabling network administrators to manage external traffic e.g., internet traffic. The DMZ Networks may enable extra protection in detecting and mitigating security breaches before they reach the cellular networks.

In other words, between each level of the automation pyramid a own firewall may be used substantially only allowing for a communication between the two levels, e.g. between field device level and automation level, but not between field device level and monitoring level. If however, the DMZ, in particular a firewall, is placed in the first cellular network, it may be possible that the first cellular network is able to communicate with every level of the automation pyramid, e.g. field level, automation level, monitoring level and planning and analysis level.

According to one embodiment, the method further comprises dividing the data item d_item into a first sub-data item sub-d_itemA and a second sub-data item sub-d_itemB, wherein the first sub-data item sub-d_itemA is a first part of the data item d_item, wherein the second sub-data item sub-d_itemB is a second part of the data item d_item, The method also provides for sending the first sub-data item sub-d_itemA through both the first cellular network and the second cellular network, and sending the second sub-data item sub-d_itemB through at least one of the first cellular network and the second cellular network. The different sub-data items may be differentiated by the priority and/or the hierarchical level. E.g. the raw data of a camera may be handled as sub-d_itemA and the processed data may be handled as sub-d_itemB.

In this way it may be possible to send data of a data stream d_item dependent on the priority and/or criticality via a highly redundant network connection and/or via a simple not redundant network connection. Highly relevant data which may have a high requirement of coming through the network because they are for example part of a time critical control loop may be extracted from the data stream, e.g. as first sub-data item sub-d_itemA. Such highly relevant data sub-d_itemA may be copied as sub-d_itemA1 and sub-d_itemA2 and be sent via the first cellular network and simultaneously over the second cellular network.

The criticality may be a measure for a grade of damage that a loss of data may cause. In this way processed data may have a higher criticality as their information content may be higher then the information content of the raw data.

However, less relevant data which may have a low requirement of coming through the network because they are for example part of a non-time critical application may also be extracted from the data stream d_item, e.g. as second sub-data item sub-d_itemB. Such low relevant data sub-d_itemB may be transmitted without copying and may be sent via the first cellular network or via the second cellular network.

In particular in an industrial network, e.g. a campus network, the predefined bandwidth may be controlled by the respective company for a low number of resources and in this way may make bandwidth allocation highly flexible. This fact may be in contrast to a public wireless network, where the bandwidth distribution and/or allocation is not as flexible as in a campus network. Thus, it may also be possible to not only use two cellular networks for building a dual redundancy. It may also be possible to increase the number of available cellular networks to a plurality of cellular in order to build a redundancy corresponding to the number of the plurality of networks. For instance, 3 parallel cellular networks, 4 parallel cellular networks or more parallel cellular networks may be reserved for building a triple, four times and/or multi-redundancy.

In an example the first sub-data item sub-d_itemA and the second sub-data item sub-d_itemB may both be extracted from the original data item d_item. In another example, it may be pre-set that that all data use a predefined first cellular network. In this case, only when data of high priority arrive, e.g. first sub-data item sub-d_itemA a copy is made for the second cellular network. In yet another example, all data may be treated as first sub-data item sub-d_itemA and copies sub-d_itemA1 and sub-d_itemA2 are made of all data item d_item. When however, data of low priority arrive, e.g. second sub-data item sub-d_itemB, the copy may be deleted and/or blocked and the second cellular network may be used for other data. For such data with low priority a queue may exist in the automation apparatus in order to fill the otherwise empty second and/or further cellular network.

In a campus network it may also be possible to have a dynamically controlled redundancy dependent on a certain location. In a company site temporarily, some additional locations may be needed to be supplied with communication capacities. E.g. temporarily some measurements may need to be taken in a specific plant by using special measurement equipment. In such cases it may be possible that this special measurement equipment may has a high requirement for reliability for transmitting the data. Having a redundancy allocation device, that may be adapted to set up temporarily and/or dynamically the redundancy levels, may increase the flexibility for a mobile network. This feature may be referred to as location-based redundancy.

In an example the automation apparatus may comprise a location detection device, e.g. a GPS receiver. As soon as the automation apparatus detects a certain location of a campus, e.g. detects the proximity to a plant where sensors with high redundancy requirements are used, the redundancy level and/or copying level may be adapted automatically and the data item is sent to each of the cellular networks according to the redundancy level. For the example of a first and a second cellular network the redundancy level may be 2.

In one example the redundancy may correspond to the number of levels of the hierarchical pyramid model. For example, the hierarchical pyramid model may have 4 levels, where data from the field device level may use a four times redundancy, the data from the third level have a triple redundancy etc. The automation apparatus may have redundancy exploring device which may request a field device, automation device, monitoring device and/or planning and analysis device for its desired redundancy level.

The method may comprise detecting the highest required redundancy level, setting up the number of cellular networks according to the highest required redundancy level and sending the data item according to the detected number of highest redundancy level, e.g. by making a corresponding number of copies of the data_item.

Using and/or allocating networks and/or bandwidth according to the criticality of the data may be advantageous for efficiently using the predefined bandwidth. For example, in case of the two data priorities for a data stream d_itemA and d_itemB it may be possible to use the second cellular network, that may substantially be unused whilst data of d_itemB are transmitted, for other data also having a low priority, e.g. backup data.

Thus, the method for redundant transmission in a distributed manufacturing automation system may comprise detecting the required redundancy level, dividing a predefined frequency band into the number of sub-bands according to the required redundancy level. The method further comprise, receiving processing data and/or a data item, generating a number of copies of the received processing data and/or data item, wherein the copies correspond to the number of available sub-bands or to a lower number than the number of available sub-bands and transmitting the generated copies of processing data and/or the data item to the sub-bands and/or to corresponding cellular networks.

The destination for the transmitted processing data and/or data item may be a receiver on a remote location. The receiver may be a server, a data network and/or a further part of a VPN (virtual private network).

The sub-bands may be different bands. Different bands may mean fully disjunct bandwidths or partially overlapping sub-bands, where different sub-bands may share parts of a bandwidth.

The automation apparatus may comprise a router, wherein the router may be adapted to generate one or more copies of a data item. The router may be additionally and/or alternatively adapted to determine the destination on a remote side for the copies, e.g. a receiver and/or a receiving device. The receiver may be adapted to extract from at least one copy of the data item a single data item and to forward the data item to a destination. The destination may be a server, a data network and/or a VPN. The receiver may be adapted to communicate with the automation apparatus, in order to determine the number of copies that may arrive at the receiver. The exchange about this information may be made via a control layer and/or control part of a network protocol. The exchange may be regularly updated in order to detect a move of the location of the automation apparatus, in cases where the location based determination of the redundancy level is made. Since automation apparatus and receiver work together the features described with regard to the automation apparatus may also be true for the receiver.

According to one embodiment, the method further comprises removing by the receiver one of the received data items based on reception time of the data items. For example, the data item with later reception time may be removed by the receiver. This may save resources that would otherwise be required to maintain duplicate copy of data items.

According to one embodiment, the submission of the data item is performed simultaneously, concurrently or substantially concurrently through the first and the second cellular network using the first and the second sub-band of the industry frequency band.

According to one embodiment, the method is automatically performed in response to detecting a trigger event by the automation apparatus. The simultaneous or concurrent transmissions of the data item d_item through the first cellular network and the second cellular network may be performed in response to detecting the trigger event. The trigger event may, for example, be a failure in the manufacturing process, the end of a timer etc.

According to one embodiment, the automation apparatus comprises a dual frequency band air interface, wherein the submissions of the data item d_item are performed using the dual frequency band air interface of the automation apparatus. For example, the automation apparatus may connect to the first base station and the second base station respectively using the dual frequency band air interface. The automation apparatus may set up a PDU Session via gNB1 to UPF1, and a PDU session via gNB2 to UPF2. UPF1 and UPF2 may connect to different or same data network (DN). In case the connection is performed to the same data network, the traffic via UPF1 and UPF2 might be routed via different user plane nodes within the data network.

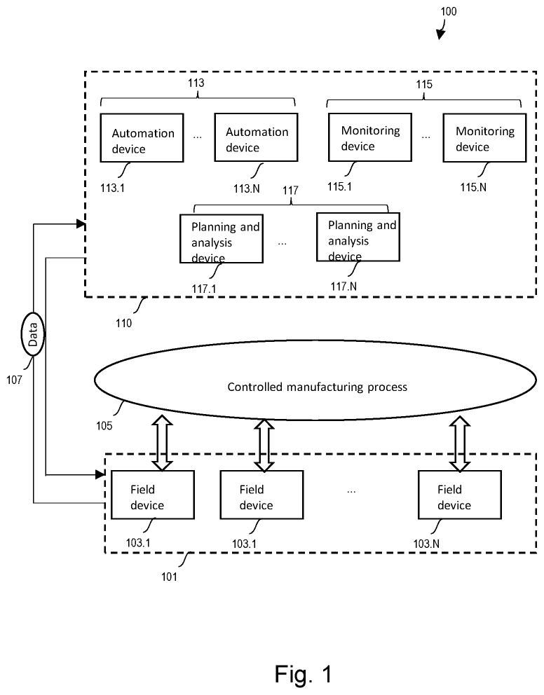

FIG. 1 depicts a distributed manufacturing automation system in accordance with an example of the present subject matter.

The distributed manufacturing automation system 100 comprises a manufacturing facility 101 having a number of field devices 103.1 through 103.N. The field devices 103.1-N may be provided with direct networking and computation capabilities. The field devices 103.1-N may include sensors, meters, motor drives, industrial robots, vision cameras, actuators or other such field devices. The field devices 103.1-N may be used to control one or more manufacturing processes 105. For that, the field devices 103.1-N may be configured to generate and/or collect process data relating to control of the manufacturing process 105. The field devices 103.1-N may be configured to transfer the process data 107 of the manufacturing process 105 to a data processing system 110 for analysis. For example, the manufacturing parameters of the manufacturing process 105 may be controlled through actuators based on the analysis.

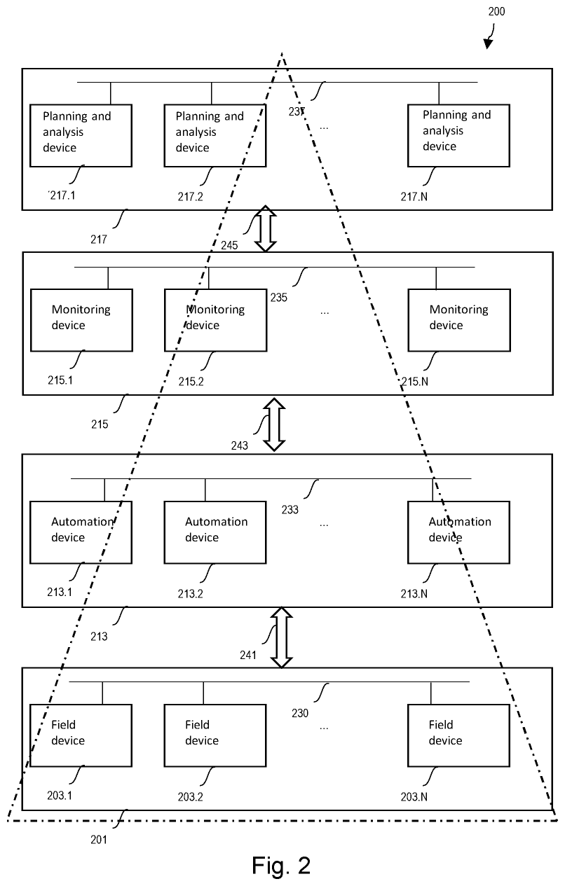

The data processing system is substantially adapted to receive process data 107, to analyze the process data 107 and to generate a data item d_item in a format that is prepared for the transmission via the automation apparatus 401. In order to use the automation apparatus 401 for process data, a criticality of the data is assessed. The criticality my defines the order of transmitting the data. The order may be defined according to the level of the hierarchical pyramid model as described in FIG. 2. Sensor data as generated by field devices 203.1-N may have a higher priority than data of a higher layer, e.g. data generated by an automation device 213.1-N or by a monitoring device 215.1-N or by a planning and analysis device 217.1-N.

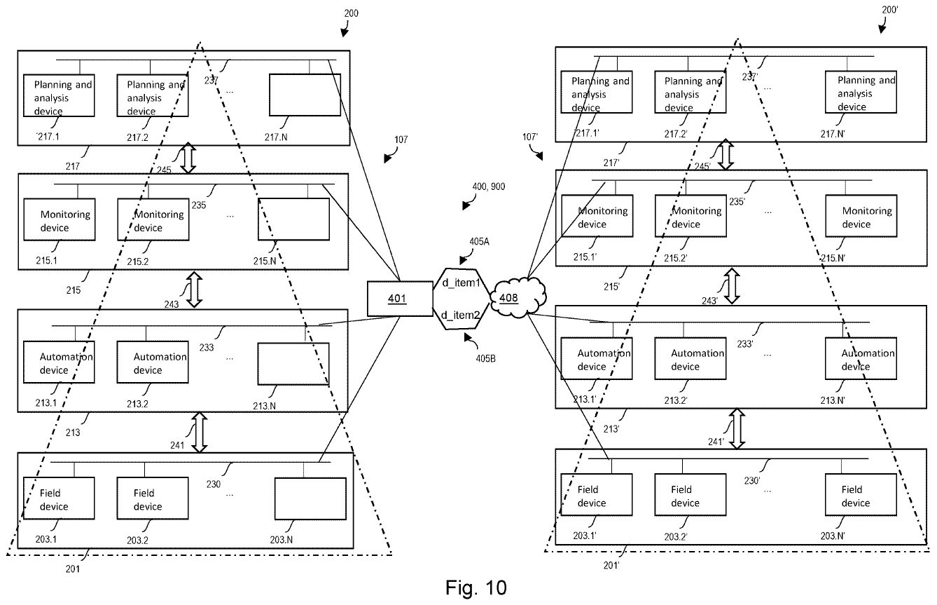

This fact of hierarchical level adapted redundant forwarding will be discussed in more details in FIG. 10.

The manufacturing process 105 may refer to the steps of a method used to prepare a composition in a manufacturing batch amount. A manufacturing process may, for example, include a joining process and/or shearing and forming process and/or molding process and/or machining process. The manufacturing process 105 may have one or more configurable manufacturing parameters such as mixing rate, temperature etc. Different types of control of the manufacturing process 105 may be used. Each type of control of the manufacturing process 105 may comprise an analysis step for analyzing of one or more manufacturing properties of the manufacturing process 105 and a control step for adjusting one or more manufacturing parameters of the manufacturing process 105 based on the analysis. The manufacturing property of the manufacturing process 105 may, for example, comprise duration, temperature, pressure, speed, quantity etc. The analysis step may comprise monitoring and/or processing of process data of the manufacturing process 105. The different types of control may differ, for example, in the type of the analysis performed and/or in the required time frame of the control e.g., one or more manufacturing parameters of the manufacturing process 105 may need to be controlled in real-time in order to meet required performance.

Each type of control of the manufacturing process 105 may require specific input data. The input data may comprise values of one or more manufacturing properties which may be obtained directly from the acquired process data 107 or be obtained after preprocessing the process data 107. In addition, each type of control of the manufacturing process 105 may have different processing resource requirement. Thus, in order to implement these different types of control of the manufacturing process 105, the data processing system 110 may be provided with different groups of devices 113, 115 and 117 each being associated with a respective type of control. Only three groups of devices are described, but it is not limited to.

The first group of devices 113 comprises automation devices 113.1-N. The automation devices 113.1-N may have a real-time capability. The automation devices 113.1-N may comprise Computer Numerical Control (CNC) machines, PLCs, etc. The automation devices 113.1-N may receive the process data 107 including manufacturing properties from various sensors and may drive actuators based on the processed sensor signals and control technique. The field devices 103.1-N together with the automation devices 113.1-N may form an automation system. Examples of automation systems may include a batch control system, continuous control system, or discrete control system.

The second group of devices 115 comprises monitoring devices 115.1-N. The monitoring devices 115.1-N may, for example, comprise Distribution Control System (DCS) devices or Supervisory Control and Data Acquisition (SCADA) devices. The monitoring devices 115.1-N facilitate intervening functions, supervising various manufacturing properties, setting production targets, historical archiving, setting machine start and shutdown, etc. The monitoring devices 115.1-N may persist, enrich/contextualize the process data 107 and made it available for consumption by other devices such as the analysis devices 117. The monitoring device 115.1-N may, for example, deploy a visualization application to enable plant operators to get insight into the persisted data and another application which implements a feedback mechanism into the devices of the first group 113 to autonomously react on certain events and adapt the manufacturing process according to generated insights.

The third group of devices 117 comprises planning and analysis devices 117.1-N. The planning and analysis devices 117.1-N may be configured to perform production planning, customer and market analysis, orders and sales, etc. The planning and analysis devices 117.1-N may, for example, be configured to carry out computationally expensive tasks like model training and validation. In another example, the planning and analysis devices 117.1-N may deploy applications that require highly available storage like long-term process data archives.

Each device of devices of the system 100 may be configured to exchange data with one or more devices of the same group to which it belongs and/or exchange data with one or more devices of the other group of devices in order to execute a task. For example, in order to perform a given type of control of the manufacturing process 105, a set of one or more of devices of the system 100 may be required. This set of devices may cooperate in order to execute the analysis step of the control using input data. The input data may be the (raw) process data 107 which is collected for the manufacturing process 105 or data obtained based on the process data 107 e.g., after pre-processing. The input data may be received at the set of devices from one or more devices of the system 100. Based on the result of the analysis, suggested adjustments of one or more manufacturing parameters of the manufacturing process may be provided by the set of devices. These adjustments may be applied by field devices such as actuators.

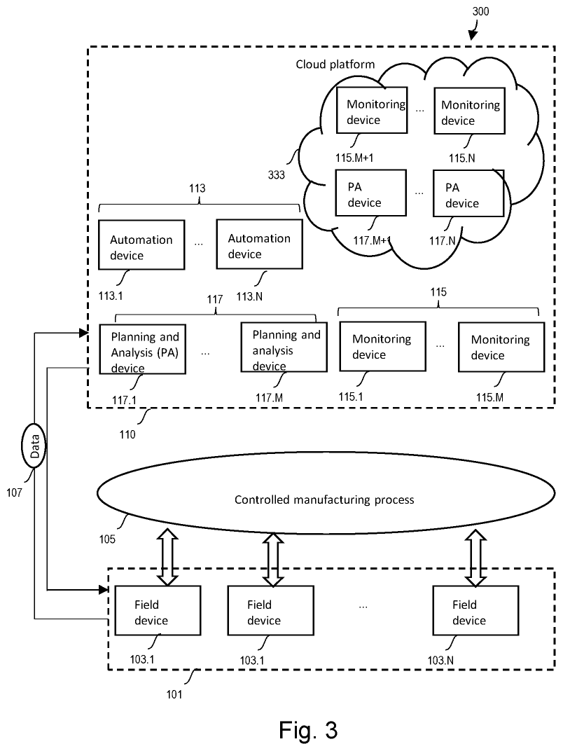

The different groups of devices may be integrated within the distributed manufacturing automation system 100 to provide continuous flow of information for the different types of control of the manufacturing process 105. The integration of the devices may be performed using different deployments and connection configurations. FIGS. 2 and 3 provide two example implementations, but it is not limited to.

FIG. 2 depicts a distributed manufacturing automation system in accordance with an example of the present subject matter.

As indicted in FIG. 2, the distributed manufacturing automation system 200 is configured according to a hierarchical pyramid model. The hierarchical pyramid model may be the ISA-95 pyramid model. With this configuration, the different groups of devices shown in FIG. 1 are connected over respective networks and the data is communicated between the manufacturing facility and the groups of devices following a predefined data flow using specific connections.

The distributed manufacturing automation system 200 is organized in different levels 201, 213, 215 and 217 of the hierarchical model. The first level 201 comprises field devices 203.1 through 203.N. The field devices 203.1-N may include sensors, meters, motor drives, industrial robots, vision cameras, actuators or other such field devices. The field devices 203.1-N may be used to monitor and/or control one or more manufacturing processes. The field devices 203.1-N may be configured to generate and/or collect process data relating to control of the manufacturing process. The field devices 203.1-N may be configured to transfer the data of the manufacturing process to the second level 213. The second level 213 comprises automation devices 213.1-N. The automation devices 213.1-N may comprise CNC machines, PLCs, etc. The automation devices 213.1-N may receive the data including manufacturing properties from various sensors and may drive actuators based on the processed sensor signals and program or control technique. The third level 215 comprises monitoring devices 215.1-N. The monitoring devices 215.1-N facilitates intervening functions, supervising various manufacturing properties, setting production targets, historical archiving, setting machine start and shutdown, etc. The monitoring devices 215.1-N may, for example, comprise DCS devices or SCADA devices. The fourth level 217 comprises planning and analysis devices 217.1-N. The planning and analysis devices 217.1-N may be configured to perform production planning, customer and market analysis, orders and sales, machine learning etc.

The devices within each level of the distributed manufacturing automation system 200 may be connected with each other over a respective network which is adapted to transmit data with the aid of a standard protocol. For example, the field devices 203.1-N may be connected with each other over a network 230. The automation devices 213.1-N may be connected with each other over a network 233. The monitoring devices 215.1-N may be connected with each other over a network 235. The planning and analysis devices 217.1-N may be connected with each other over a network 237.

The field devices 203.1-N may communicate with the automation devices 213.1-N via a connection 241. The connection 241 may be an analogue connection, field bus based connection or Ethernet based connection. The automation devices 213.1-N may communicate with the monitoring devices 215.1-N via a connection 243. The connection 243 may be an Ethernet based connection. The monitoring devices 215.1-N may communicate with the planning and analysis devices 217.1-N via a connection 245. The connection 245 may be an Ethernet based connection. Each of the connections 241, 243 and 245 may be provided with a firewall that controls the communication of the data through the respective connection.

The devices of the distributed manufacturing automation system 200 may cooperate according to this hierarchical model in order to perform different types of control of the manufacturing process. For example, using the system 200, an operating division of a chemical company may monitor its production quality and actively react to product quality issues by automatically generating feedback to the automation system.

FIG. 3 depicts a distributed manufacturing automation system in accordance with an example of the present subject matter.

The distributed manufacturing automation system 300 provides an example implementation of the data processing system 110 of the system of FIG. 1. At least part of the second and third groups of devices may be implemented in a cloud platform 333 to leverage cloud-based applications and services. The cloud platform 333 may, for example, be provided by a cloud provider as a platform-as-a-service (PaaS). For example, a subgroup 115.1 to 115.M of the second group of devices 115 may be implemented as a local data center and the remaining subgroup 115.M+1 to 115.N may be implemented in the cloud platform 333. Alternatively of additionally, a subgroup 117.1 to 117.M of the third group of devices 115 may be implemented as a local data center and the remaining subgroup 117.M+1 to 117.N may be implemented in the cloud platform 333. The devices in the cloud platform 333 may be configured to communicate through the internet in order to exchange data with other devices of the data processing system 110. The devices of the local data centers as well as the devices of the cloud platform may cooperate in order to perform different types of control of the manufacturing process.

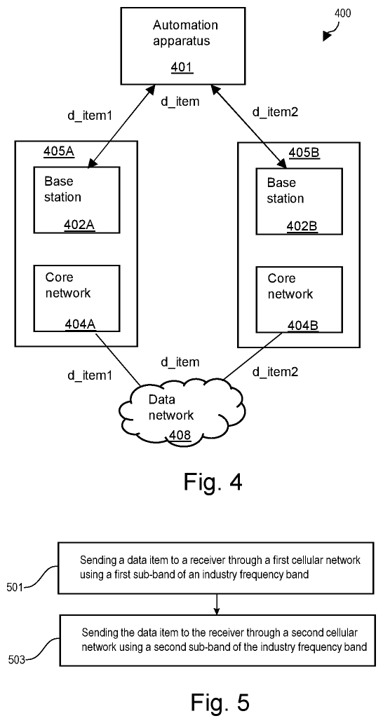

FIG. 4 depicts a wireless communication system according to an example of the present subject matter.

The wireless communication system 400 includes a first cellular network 405A and a second cellular network 405B. The first cellular network 405A includes a base station 402A which communicates over a transmission medium with an automation apparatus 401. The second cellular network 405B includes a base station 402B which communicates over a transmission medium with the automation apparatus 401. The automation apparatus 401 may be the automation apparatus may be any device of the field devices, automation devices, monitoring devices and planning and analysis devices as described with reference to FIG. 1, FIG. 2 and FIG. 3.

The base stations 402A-B may be base transceiver stations (BTS) and may include hardware that enables wireless communication with the automation apparatus 401. The base station 402A may be coupled to core network 404A. The base station 402B may be coupled to core network 404B. Each core network 404A-B may also be coupled to one or more data networks such as data network 408, which may include the Internet, a Public Switched Telephone Network (PSTN), and/or any other network. Thus, the base stations 402A-B may facilitate communication between the automation apparatus 401 and the networks 404A, 404B, and 408.

The base stations 402A-B and the automation apparatus may be configured to communicate over the transmission medium using various radio access technologies (RATs), such as long-term evolution (LTE) and 5G new radio (5G NR) etc. Base station 402A and core network 404A may operate according to a first RAT (e.g., 5G NR) while base station 402B and core network 404B may operate according to the same RAT or a second RAT (e.g., LTE). The two core networks may be controlled by the same network operator (e.g., cellular service provider), or by different network operators. In addition, the two core networks may be operated independently of one another.

FIG. 5 is a flowchart of a method for redundant transmission in a distributed manufacturing automation system according to an example of the present subject matter. The method described in FIG. 5 may be performed by an automation apparatus such as the automation apparatus 401 described with reference to FIG. 4.

The automation apparatus 401 may send in step 501 a data item to a receiver through the first cellular network 405A using a first sub-band of an industry frequency band. The automation apparatus 401 may send in step 503 the same data item to the same receiver through the second cellular network 405B using a second sub-band of the industry frequency band. The data item may comprise one or more data packets whose content represent acquired values of one or more manufacturing properties of the manufacturing process.

The automation apparatus 401 may, for example, send the same data item simultaneously through the first and second cellular networks 405A and 405B.

The method of FIG. 5 may be repeated on a periodic basis e.g., every minute. In another example, the method may automatically be performed in response to detecting a trigger event by the automation apparatus 401. The data item may comprise the currently acquired values of one or more manufacturing properties of the manufacturing process. Thus, the data item sent in each iteration may be different from the data item submitted in another iteration.

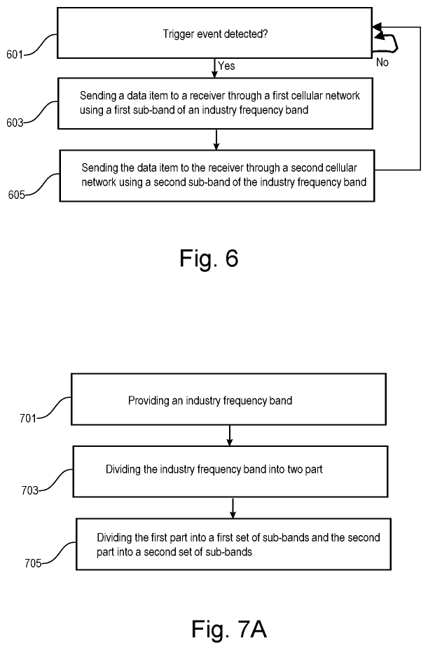

FIG. 6 is a flowchart of a method for redundant transmission in a distributed manufacturing automation system according to an example of the present subject matter. The method described in FIG. 6 may be performed by an automation apparatus such as the automation apparatus 401 described with reference to FIG. 4.

It may be determined in step 601 whether a trigger event is detected. The trigger event, may, for example, be detected by the automation apparatus 401. If so, steps 603 and 605 may be performed; otherwise, it may be waited until the trigger event is detected. The automation apparatus 401 may send in step 603 a data item to a receiver through the first cellular network 405A using a first sub-band of an industry frequency band. The automation apparatus 401 may send in step 605 the same data item to the same receiver through the second cellular network 405B using a second sub-band of the industry frequency band. The automation apparatus 401 may, for example, send the same data item simultaneously through the first and second cellular networks 405A and 405B. As indicated in FIG. 6, the method steps 601 to 605 may repeatedly be performed e.g., the method may be repeated until a stop criterion is fulfilled, wherein the stop criterion may, for example, require that a maximum number of iterations is reached.

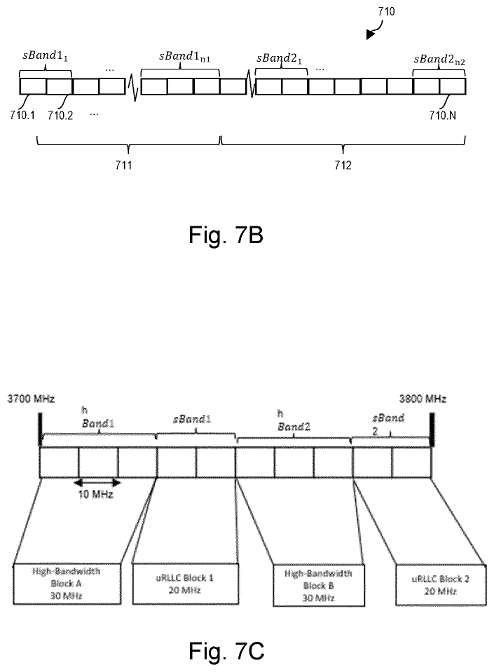

FIG. 7A is a flowchart of a method for frequency allocation according to an example of the present subject matter. For the purpose of explanation, the method described in FIG. 7A may be implemented in the system illustrated in FIG. 4 but is not limited to this implementation.

An industrial frequency band 710 or the predefined frequency band 710 as shown in FIG. 7B may be provided in step 701. The predefined frequency band 710 or industry frequency band may be provided in multiples of a frequency block 710.1 through 710.N The width w of the frequency block may, for example, be 10 MHz (W_{block}=10 MHz), 5 MHz (W_{block}=5 MHz) or other values.

The distribution of the different frequency bands and/or sub-frequency bands may be adapted to an individual traffic characteristic. That characteristic may be determined by a traffic measurement. It also may be dependent on the location of the industrial processes. Different plants in a site of a chemical production network may have different traffic requirements. In this way, the sub-band allocation may be adapted to the layout of an industrial site.

The predefined frequency band 710 or the industrial frequency band 710 may be divided in step 703 in two parts 711 and 712. The first part 711 may be allocated for the transmissions by the automation apparatus 401 through the first cellular network 405A. The second part 712 may be allocated for the transmissions by the automation apparatus 401 through the second cellular network 405B.

The first part 711 of the industrial frequency band 710 may be divided in step 705 into a first set of n1 sub-bands sBand1₁, sBand1₂ . . . sBand1ₙ₁. The second part 712 of the industrial frequency band 710 may be divided in step 705 into a second set of n2 sub-bands sBand2₁, sBand2₂ . . . sBand2ₙ₂.

The first sub-band sBand1 may be any one of the first set of sub-bands e.g., sBand1=sBand1ₙ₁. The second sub-band sBand2 may be any one of the second set of sub-bands e.g., sBand2=sBand1₁.

The first set of sub-bands sBand1₁, sBand1₂ . . . sBand1ₙ₁ may or may not have the same frequency range. The second set of sub-bands sBand2₁, sBand2₂ . . . sBand2ₙ₂ may or may not have the same frequency range. The number of sub-bands n1 in the first set may or may not be equal to the number of sub-bands n2 in the second set.

In one example implementation as illustrated in FIG. 7C, the dual frequency band may be a 3700-3800 MHz band, the frequency range of the block is 10 MHz (W_{block}=10 MHz), the number n1 of sub-bands may be equal to two, n1=2 and the number n2 of sub-bands may be equal to two, n2=2. The first set of sub-bands comprises the first sub-band sBand1 and another sub-band, named first broad sub-band hBand1 for transmission of high bandwidth data. Similarly, the second set of sub-bands comprises the second sub-band sBand2 and another sub-band, named second broad sub-band hBand2 for transmission of high bandwidth data. The sub-bands sBand1, hBand1, sBand2 and hBand2 occupy the frequency ranges W_{sBand1}, W_{hBand1}, W_{sBand2} and W_{hBand2} respectively. The ratio between the high-bandwidth sub-band and the associated uRLLC sub-band can vary. For example, W_{sBand1}<W_{hBand1} and W_{sBand2}<W_{hBand2}. In one example, the

$${W}_{sBand 1} = \frac{2}{\text{?}} \times {W}_{hBand 1} and {W}_{sBand 2} = \frac{2}{\text{?}} \times {W}_{hBand 2} .$$

$$\text{?} \text{indicates text missing or illegible when filed}$$

Alternatively, or additionally, W_{sBand1}=W_{sBand2} and W_{hBand1}=W_{hBand2}. FIG. 7C shows the example of W_{sBand1}=W_{sBand2}=20 MHz and W_{hBand1}=W_{hBand2}=30 MHz, but it is not limited to as explained above.

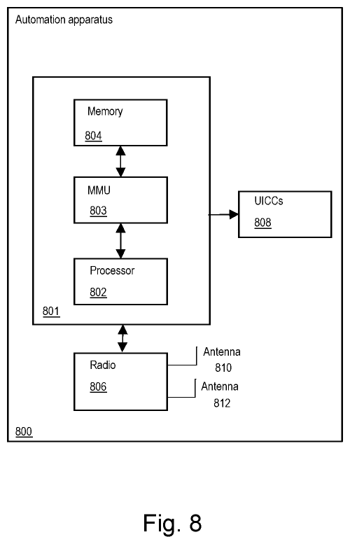

FIG. 8 depicts an example simplified block diagram of an automation apparatus according to an example of the present subject matter.

The automation apparatus 800 may comprise a System-on-a-Chip (SOC) 801 including processor(s) 802, which may execute program instructions for the automation apparatus 800. The processor(s) 802 may be coupled to memory management unit (MMU) 803 of the SOC 801, which may be configured to receive addresses from the processor(s) 802 and translate those addresses to locations in a memory 804 of the SOC 801 and/or to other circuits or devices, such as cellular communication circuitry. The automation apparatus 800 may further include a cellular communication circuitry 806 such as for 5G, LTE, etc. The automation apparatus 801 may further comprise two or more smart cards 808 that each comprises SIM functionality, such as two or more Universal Integrated Circuit Cards (UICCs) 808. The cellular communication circuitry 806 may couple to one or more antennas, preferably two antennas 810 and 812. It is to be noted that the automation apparatus 800 shown in FIG. 8 may comprise several further elements or functions besides those described herein below, which are omitted herein for the sake of simplicity as they are not essential for the understanding.

The inclusion of two or more SIM cards 808 may allow the automation apparatus to support two different identifiers and may allow the automation apparatus 800 to communicate on corresponding two or more respective networks. The cellular communication circuitry 806 may comprise two distinct radios, each having a receive chain and a transmit chain. The two radios may support separate RAT stacks.

The processor 802 is configured to execute processing related to the above described subject matter. For example, the processor 802 may be configured to execute the method of FIG. 5, FIG. 6 or FIG. 7A.

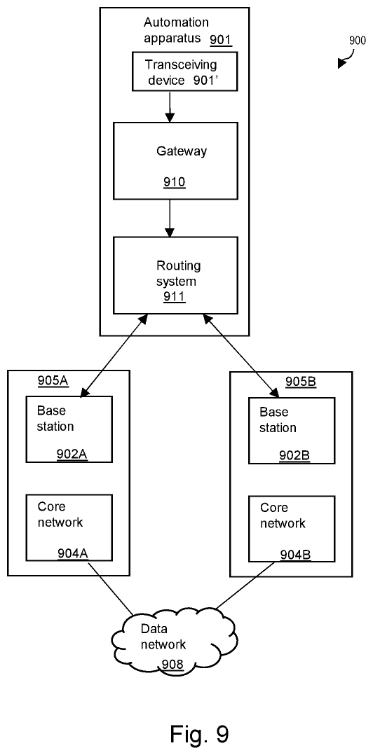

FIG. 9 depicts a wireless communication system according to an example of the present subject matter.

The wireless communication system 900 includes an automation apparatus 901, the automation apparatus 901 comprises a transceiving device 901′, a gateway 910 and a routing system 911. In one example, the routing system 911 may comprise one router 911 having two modems/chips integrated and can communicate over these two modems simultaneously. Alternatively, the routing system 911 may comprise two routers which do not have this dual transmission capability. The router may, for example, be a 5G router. The transceiving device 901′ may be adapted to receive and/or transmit data. The transceiving device may allow a bidirectional communication. In an example the transceiver 901′ receives process data 107 or data of any level of the hierarchical pyramid model and forwards it to the cellular networks 905A, 905B according to the required redundancy. The communication may also be made in the opposite direction. In an example the transceiving device may comprise the allocation device and/or scheduling device.

The automation apparatus 901 may not be provided with direct networking capabilities. The wireless communication system 900 includes a first cellular network 905A and a second cellular network 905B. The first cellular network 905A includes a base station 902A which communicates over a transmission medium with the corresponding router in the routing system 911. The second cellular network 905B includes a base station 902B which communicates over a transmission medium with the corresponding router in the routing system 911. In case the rooting system 911 comprises one router, the two base stations may communicate through that router.

The base stations 902A-B may be base transceiver stations (BTS) and may include hardware that enables wireless communication with the routing system 911. The base station 902A may be coupled to core network 904A. The base station 902B may be coupled to core network 904B. Each core network 904A-B may also be coupled to one or more data networks such as data network 908, which may include the Internet, a Public Switched Telephone Network (PSTN), and/or any other network.

The automation apparatus 901 may be configured to communicate with the data network 908 through the gateway 910 and the routing system 911. Communicating with the data network 908 refers to a communication with a receiver such as an application server that is connected to the data network 908. For example, the automation apparatus 901 may send two copies of the data item to the gateway 910. The gateway may forward the two copies of the data item to the routing system 911. In case the routing system 911 comprises a single router, that single router may send one copy of the data item through the first cellular network 905A to the data network 908 and send the other copy of the data item through the second cellular network 905B to the data network 908. In case the routing system 911 comprises two routers, a first router may send one copy of the data item through the first cellular network 905A to the data network 908 and the second router may send the other copy of the data item through the second cellular network 905B to the data network 908. The receiver that is connected over the data network 908 may receive the two copies of the data item.

The base stations 902A-B and the routing system 911 may be configured to communicate over the transmission medium using various radio access technologies (RATs), such as LTE and 5G NR etc. Base station 902A and core network 904A may operate according to a first RAT (e.g., 5G NR) while base station 902B and core network 904B may operate according to the same RAT or a second RAT (e.g., LTE). The two core networks may be controlled by the same network operator (e.g., cellular service provider), or by different network operators. In addition, the two core networks may be operated independently of one another (e.g., if they operate according to different RATs), or may be operated in a coupled or tightly coupled manner.

The system of FIG. 9 may advantageously be used in case the automation apparatus 901 does not have a direct networking capability e.g., the automation apparatus is not a 5G-ready end device.

The following is an alternative example of transmission of the data item. For the communication between the automation apparatus 901 and the receiver, there may, for example, be two directions, a push direction from the automation apparatus to the receiver and a pull direction from the receiver to the automation apparatus.

In the push direction, the sending of a data item is initiated be the automation apparatus (e.g., in response to the event ‘hand valve opened’). In case of the event, the automation apparatus sends a data item (item A) to the sensorics gateway 910. In case of a routing system with two routers, named router #1 and router #2, the gateway 910 sends the data item to the router #1. With the receiving of the data item, the router #1 duplicates the data item resulting in item A and item B. Item A is sent over the integrated modem of router #1 over the first cellular network 905A to the destination ip-address of the receiver. The item B is sent via an ethernet interface to the router #2. Then, the router #2 sends the item B over its integrated modem to the destination ip-address of the receiver over the second cellular network 905B. In case of a router with two integrated modems, the router may duplicate the item A to obtain item B. The item A may be transferred over modem #1 of the router over the first cellular network 905A to the destination ip-address of the receiver. The item B may be transferred over modem #2 in the same router over the second cellular network 905B to the destination ip-address of the receiver. The receiver then deletes the second incoming item. Alternatively, if the duplication/elimination process is implemented on a lower OSI-layer, the elimination can be a function of the cellular network itself (e.g., the core). In this case, the receiver only receives one item from the cellular network.

In the pull direction, if the receiver is pulling the data from the sensorics gateway 910, it asks for the current values of two different servers associated with two different ip-addresses. For example, the receiver may send a pull request to the automation apparatus for pulling data, wherein the pull request triggers the redundant transmission of the data item. The application on the receiver may, thus, eliminate the second incoming item.

FIG. 10 depicts a distributed manufacturing automation system 100, 200, 200′ distributed over different locations linked by a wireless communication system 400, 900 in accordance with an example of the present subject matter.

The distributed manufacturing automation system 100, 200, 200′ may be distributed between different locations of a campus network. In an example sensors 203.1-N are distributed on one site, e.g. the automation site 200, and planning and analysis devices 217.1-N are located on the other site, e.g. a SCADA analysis device.

Each layer or level of the hierarchical model may form a layer specific network. The field device level 201, 201′ links the field devices 203.1-N and 203.1′-203N′ via a field device network 230, 230′. The automation device level 213 links the automation devices 213.1-N and 213.1′-213N′ via an automation device network 237, 237′ . . . . The monitoring device level 215 links the monitoring devices 215.1-N and 215.1′-215N′ via a monitoring device network 235, 235′. The planning and analysis device level 217, 217′ links the planning and analysis devices 217.1-N and 217.1′-217N′ via a planning and analysis device network 237, 237′.

The field device network 230, 230′, automation device network 233, 233′, monitoring device network 235, 235′ and automation device network 237, 237′ have different segments that are linked by the wireless communication system 400, 900 comprising the automation apparatus 401. The networks 230, 230′, 233, 233′, 235, 235′, 237, 237′ may be configured as VPN 230, 230′, 233, 233′, 235, 235′, 237, 237′. Each VPN 230, 230′, 233, 233′, 235, 235′, 237, 237′ may substantially forms its own domain.

Connections 241, 243, 245 may be network elements such as a bridge, a switch, a gateway and/or router that may allow data exchange between the different VPNs 230, 230′, 233, 233′, 235, 235′, 237, 237′.

Each VPN 230, 230′, 233, 233′, 235, 235′, 237, 237′ may have its own redundancy requirements. In an example the field device level 201, 201′ may comprise a plurality of time critical data and may require a high redundancy. Therefore, a data item generated in the field device level 201, 201′ may be transmitted via wireless communication system 400, 900 by using at least two different sub-bands of different cellular networks.

The planning and analysis level 201, 201′ may comprise substantially time uncritical data or non-time critical data and may require a low redundancy. Therefore, a data item generated in the planning and analysis level 217, 217′ may be transmitted via wireless communication system 400, 900 by using substantially only a single sub-band of only one single cellular network.

FIG. 10 also shows that if one of the field devices 203.1, shown in FIG. 10 on the left side, want to reach an automation device 213,1′, shown in FIG. 10 on the right side, it may involve the high redundancy connection in the wireless communication system 400, 900, even if time uncritical inter-level connections 241′, 243′, 245′ are used. The inter-level connections 241′, 243′, 245′ may be non-time critical or may not need high redundancy as they may be located on the same physical location and may be connected by physical wire with a substantially low error rate.

The automation apparatus 401 may be adapted to assess a required overall reliability and determine the appropriate need for a redundancy between automation apparatus 401 and data network 408.

Different networks 230, 230′, 233, 233′, 235, 235′, 237, 237′ may be allocated to different redundancy requirements within the automation apparatus 401.

One of the automation systems 200, 200′ may be dynamically changing its location. Dependent on the current location different redundancy configurations may be set up.

The automation apparatus 401 collects process data of every network 230, 230′, 233, 233′, 235, 235′, 237, 237′. Thus, the automation apparatus 401 may have a plurality of different network interfaces. In an example the networks 230, 230′, 233, 233′, 235, 235′, 237, 237′ may be oriented according to the hierarchical pyramid model. In this case the automation apparatus may have a field device interface or sensor interface that may be used in the field device network 230. In an example the field device interface may be an analog interface. In addition, and/or as an alternative the automation apparatus may have an automation device interface that may be used in the automation device network 230, a monitoring device interface that may be used in the monitoring device network 235 and/or a planning and analysis device interface that may be used in the planning and analysis device network 237. The automation device interface, monitoring device interface and/or planning and analysis device interface may be a digital interface, e.g. Ethernet, on the physical network layer according to the OSI (Open Systems Interconnection model) and they may comprise different logical interfaces, dependent on the OSI level, each of the networks 233, 235, 237. The logical interface may be implemented according to the OSI level each of the networks is working. The automation devices may have a corresponding logical interface according to the OSI layer of the connected device and/or network.

As will be appreciated by one skilled in the art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon. A computer program comprises the computer executable code or “program instructions”.

Any combination of one or more computer readable medium(s) may be utilized. The computer readable medium may be a computer readable storage medium. A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device.

‘Computer memory’ or ‘memory’ is an example of a computer-readable storage medium. Computer memory is any memory which is directly accessible to a processor.

‘Computer storage’ or ‘storage’ is a further example of a computer-readable storage medium. Computer storage is any non-volatile computer-readable storage medium. In some embodiments computer storage may also be computer memory or vice versa.

A ‘processor’ as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object oriented programming language such as Java, Smalltalk, C++ or the like and conventional procedural programming languages, such as the “C” programming language or similar programming languages and compiled into machine executable instructions. In some instances, the computer executable code may be in the form of a high level language or in a pre-compiled form and be used in conjunction with an interpreter which generates the machine executable instructions on the fly.

Generally, the program instructions can be executed on one processor or on several processors. In the case of multiple processors, they can be distributed over several different entities. Each processor could execute a portion of the instructions intended for that entity. Thus, when referring to a system or process involving multiple entities, the computer program or program instructions are understood to be adapted to be executed by a processor associated or related to the respective entity.

1. A method for redundant transmission in a distributed manufacturing automation system, the method comprising:
sending by an automation apparatus of the system a data item (d_item) to a receiver through a first cellular network using a first sub-band of a predefined frequency band, the first cellular network comprising a first base station and a first core network device; and
sending by the automation apparatus the data item (d_item) to the receiver through a second cellular network using a second sub-band of the predefined frequency band, the second cellular network comprising a second base station and a second core network device:
wherein the first sub-band and the second sub-band are different sub-bands.

2. The method of claim 1,
wherein the sending of the data item (d_item) through the first cellular network comprises:
selecting a first user plane path between the automation apparatus and a data network comprising the receiver, the first user plane path comprising a first user plane function network element of the first core network device; and
sending the data item along the first user plane path,
wherein the sending of the data item (d_item) through the second cellular network comprises:
selecting a second user plane path between the automation apparatus and the data network, the second user plane path comprising a second user plane function network element, UPF2, of the second core network device; and
sending the data item along the second user plane path.

3. The method of claim 1, further comprising:
sending the data item (d_item) to a sensor gateway of the automation apparatus;
forwarding the data item (d_item) by the sensor gateway of the automation apparatus through a physical connection to a router of the automation apparatus; and
forwarding over the air by the router the data item (d_item) to the first cellular network;
wherein the sending of the data item (d_item) through the first cellular network comprises:
forwarding over the air by the router the data item to the first cellular network; and
wherein the sending of the data item (d_item) through the second cellular network comprises:
forwarding over the air by the router the data item to the second cellular network.

4. The method of claim 1, wherein the automation apparatus comprising a dual frequency band air interface, and wherein sending of the data item (d_item) through the first cellular network and sending of the data item (d_item) through the second cellular network is performed using the dual frequency band air interface of the automation apparatus.

5. The method of claim 1, wherein the predefined frequency band being divided into two sets of sub-bands, a first set of sub-bands (sBand1₁, sBand1₂, sBand1ₙ₁) being allocated for transmission through the first cellular network and a second set of sub-bands (sBand2₁, sBand2₂, sBand2ₙ₂) being allocated for transmission through the second cellular network, wherein the first sub-band (sBand1₁) is part of the first set of sub-bands and the second sub-band (sBand2₁) is part of the second set of sub-bands.

6. The method of claim 5, wherein the first set of a first number (n1) of sub-bands comprises a first broad sub-band (hBand1) for high data rates, and the second set of a second number (n2) of sub-bands comprises a second broad sub-band (hBand2) for high data rates.

7. The method of claim 6, wherein the data item (d_item) that is sent through the first cellular network using the first sub-band and through the second cellular network using the second sub-band is a first type of data, the method further comprising:
sending by the automation apparatus to the receiver a second type of data through the first cellular network using the first broad sub-band and/or sending by the automation apparatus to the receiver the second type of data through the second cellular network using the second broad sub-band.

8. The method of claim 6, wherein the data item (d_item) that is sent through the first cellular network using the first sub-band and through the second cellular network using the second sub-band is a first type of data, the method further comprising:
sending by the automation apparatus to the receiver a second type of data through the first cellular network using the first broad sub-band and/or sending by the automation apparatus to the receiver the second type of data through the second cellular network using the second broad sub-band.

9. The method of claim 6, wherein the first-sub band and the first broad sub-band are provided such that the sum of the bandwidths of the first sub-band and the first broad sub-band form the bandwidth of the first set of sub-bands, wherein the second sub-band and the second broad sub-band are provided such that the sum of the bandwidths of the second sub-band and the second broad sub-band form the bandwidth of the second set of sub-bands.

10. The method of claim 1, further comprising:
dividing the data item (d_item) into a first sub-data item (sub-d_itemA) and a second sub-data item (sub-d_itemB):
wherein the first sub-data item (sub-d_itemA) is a first part of the data item (d_item); and
wherein the second sub-data item (sub-d_itemB) is a second part of the data item (d_item):
sending the first sub-data item (sub-d_itemA) through the first cellular network and the second cellular network; and
sending the second sub-data item (sub-d_itemB) through at least one of the first cellular network and the second cellular network.

11. The method of claim 1, further comprising removing by the receiver one of the received data items based on reception time of the data items.

12. The method of claim 1, wherein the submission of the data item being performed simultaneously through the first and the second cellular network using the first and the second sub-band of the predefined frequency band.

13. The method of claim 1, wherein the method is automatically performed in response to detecting a trigger event by the automation apparatus; and
wherein the trigger event is one of receiving data, receiving a predefined data type, elapsing of a timer, overflow of a buffer and detecting a failure.

14. A computer program product comprising a computer-readable storage medium having computer-readable program code embodied therewith, the computer-readable program code configured to implement the method of claim 1.

15. A system comprising:
a first cellular network and a second cellular network,
the first cellular network comprising a first base station and a first core network device,
the second cellular network comprising a second base station and a second core network device, and
the system further comprising an automation apparatus, the automation apparatus being configured for:
sending a data item (d_item) to a receiver through the first cellular network using a first sub-band of a predefined frequency band; and
sending the data item (d_item) to the receiver through the second cellular network using a second sub-band of the predefined frequency band.

16. An automation apparatus for a distributed manufacturing automation system, the automation apparatus comprising a dual band air interface and a processor being configured for:
sending using the interface a data item to a receiver through a first cellular network using a first sub-band of a predefined frequency band, the first cellular network comprising a first base station and a first core network device; and
sending using the interface the data item to the receiver through a second cellular network using a second sub-band of the predefined frequency band, the second cellular network comprising a second base station and a second core network device.
